(19) United States
(12) Patent Application Publication
(10) Pub. No.: US 2014/0134967 A1
(43) Pub. Date: May 15, 2014

(54) VIRTUAL N-BAND LNB

(71) Applicants: Henrik Huber-Roos, Copenhagen (DK); Lars Theil Hansen, Hoersholm (DK); Ulrich Vesterager Gothelf, Maaloev (DK)

(72) Inventors: Henrik Huber-Roos, Copenhagen (DK); Lars Theil Hansen, Hoersholm (DK); Ulrich Vesterager Gothelf, Maaloev (DK)

(73) Assignee: THRANE & THRANE A/S, Kgs. Lyngby (DK)

(21) Appl. No.: 14/128,901

(22) PCT Filed: Jun. 22, 2012
(86) PCT No.: PCT/EP2012/062140

§ 371 Date: Dec. 23, 2013

Related U.S. Application Data
(60) Provisional application No. 61/500,701, filed on Jun. 24, 2011.

(51) Int. Cl. H04B 1/06

(52) U.S. Cl. CPC H04B 1/06
USPC 455/188.1

(57) ABSTRACT

A system for receiving information, the system comprising a receiver being configurable to receive signals within a plurality of first frequency bands and output a second signal relating to a signal received within a selected one of the first frequency bands, a processing element adapted to receive and process a third signal being within a predetermined, second frequency band, each first frequency band being wider in frequency than the second frequency band, and an intermediate element adapted to receive the second signal, generate the third signal by selecting, from the second signal, information with a frequency within the second frequency band, and output the third signal. Thus, in satellite communication, a 2 LO LNB may be made to appear as a 4 LO LNB seen from the Modem.

The present invention relates to a virtual N-band Low Noise Block (LNB), and in particular to a system able to use cheaper LNBs together with legacy satellite modems and the like, which however, are not made to co-operate with such LNBs.

VSAT Modems designed today typically have a RX (Receive) IF (Intermediate Frequency) range from 950 to 2000 MHz at least. This allows the Modem to cover the VSAT RX band (10.70 to 12.75 GHz) with 2 LNB Local Oscillators (LOs). If the LOs are selected to be 9.75 and 10.75 GHz, the lower half of the VSAT band (10.70 to 11.70 GHz) will be transferred to the IF range 950 to 1950 MHz, and the upper half of the VSAT band (11.70 to 12.75 GHz) will be transferred to the IF range 950 to 2000 MHz. LNBs with dual LO are common, and available at reasonable cost. Selection of the required LO frequency is either programmed by a human operator or signalled electronically from the Modem to the LNB. One bit is required to select one of two LOs.

VSAT Modems older than a few years (plus some manufactured today by conservative manufacturers) only have a RX IF range from 950 to 1500 MHz. This allows the Modem to cover the VSAT RX band (10.70 to 12.75 GHz) with 4 LNB LOs. If the LOs are selected to be 9.75, 10.25, 10.75 and 11.25 GHz, the lower quarter of the VSAT band (10.70 to 11.20 GHz) will be transferred to the IF range 950 to 1450 MHz, the second quarter of the VSAT band (11.20 to 11.70 GHz) will again be transferred to the IF range 950 to 1450 MHz, the third quarter of the VSAT band (11.70 to 12.20 GHz) will again be transferred to the IF range 950 to 1450 MHz and the upper quarter of the VSAT band (12.20 to 12.75 GHz) will be transferred to the IF range 950 to 1500 MHz. Selection of the required LO frequency is either programmed by a human operator or signalled electronically from the Modem to the LNB. Two bits are required to select one of four LOs.

Due to lower availability, higher cost and increased logistical complexity, it is not always attractive to use 4-band LNBs.

The present invention relates to a solution where such newer LNBs may be used together with e.g. legacy satellite modems.

According to an aspect of the invention, the 2 LO LNB is made to appear as a 4 LO LNB seen from the Modem.

Thus, a first aspect of the invention relates to a system for receiving information, the system comprising:
a receiver being configurable to receive signals within a plurality of first frequency bands and output a second signal relating to a signal received within a selected one of the first frequency bands,
a processing element adapted to receive and process a third signal being within a predetermined, second frequency band, each first frequency band being wider in frequency than the second frequency band, and
an intermediate element adapted to receive the second signal, generate the third signal by selecting, from the second signal, information with a frequency within the second frequency band, and output the third signal.

In the present context, the receiver is able to receive signals, typically encoded and carried on a carrier frequency, which may be clearly discernible or more embedded in the signal. In situations where a signal has a carrier frequency, this frequency is taken as that of the signal. Usually, frequencies are provided in pre-determined or predefined bands, as is the case in satellite communication where IEEE has defined Radio-frequency bands. Pre-defined bands may be the HF, VHF, UHF, L band, S band, C band and X band, Ku band, K band, Ka band, V band, W band or mm band intervals.

The receiver is configurable to receive signals within a plurality of first frequency bands. In this respect, the receiver is adapted to output the second signal. Thus, the receiver may in one situation be able to receive signals within all of the first frequency bands and then derive there from the second signal, such as by filtering out signals with a frequency within the selected first frequency band. A widely used manner of obtaining this is to provide a local oscillator for each first frequency band and use this oscillator for isolating the signals within the selected first frequency band.

Alternatively, the receiver may comprise a filtering element adapted to allow only signals with a frequency within the selected first frequency band to be received by the receiver.

This configuration may be a physical setting, such as the setting of a switch of the receiver or positioning of a filter between the receiver and a transmitter of the signal. Alternatively, the identity of the selected first frequency band may be fed to the receiver as a controlling signal, as will be described further below.

Any number, exceeding 1, of first frequency bands may be used. Typically, especially in LNBs, 2, 3 or 4 such bands may be selected from, but it is clearly within the present technology to provide an LNB with more selectable frequency bands.

Naturally, any first frequency bands may be defined. These may overlap or not, and these bands may have identical or different widths.

Naturally, a selection of another first frequency band will make the receiver subsequently output the second signal now within this frequency band.

The second signal relates to a signal received within a selected one of the first frequency bands. In this respect, this relation preferably may be a part of the signal received within the selected first frequency band, such as when filtered or selected there from. Naturally, the second signal may correspond to all parts of the signal received within the selected first frequency band, or only part thereof, if desired. Preferably, all parts of the received signal within the selected frequency band are output.

The third signal is within a predetermined second frequency band which is narrower than any of the first frequency bands. Preferably, one or more of the first frequency bands has a width which is, in frequency, a multiple of (an integer multiplied to) the width of the second frequency interval. However, any relation may be used, such as a second frequency interval having a width of 90% or less, such as 80% or less, preferably 70% or less, such as 60% or less, such as 50% or less, such as 40% or less, such as 25% or less, such as 10% or less than the width of one of the first frequency bands.

The processing element may have many reasons for only accepting signals within the second frequency band, such as only a single local oscillator locked to this frequency interval. Thus, the processing element may not be easily altered to accept another frequency band or a wider/narrower frequency band.

The second signal may have a frequency, such as a carrier frequency, falling within the frequency interval/band of the selected first frequency band/interval. However, the second signal may have other frequencies, which may be the case, if e.g. the carrier frequency of the signal received within the selected first frequency band has been replaced (up/down mixing) with another carrier frequency. This may be performed in order to provide multiple such signals on the same communication link.

The same may be the situation with the third signal which may also have the same or another frequency or frequency contents than the second signal. Such changes in frequency are standard to the skilled person.

The processing element may perform any processing of the third signal, such as a frequency conversion, a demodulation, a decoding, a decryption, or the like. Also, a subsequent conversion, encoding, modulation, encryption or the like may also be performed. The output signal may have any desired format or protocol, such as Ethernet, HDMI or the like.

The processing element may subsequently output a signal relating to the received and processed third signal. This output signal may be data, a TV signal, an audio signal, or the like.

In one situation, the processing element is a modem as is usually used for receiving signals from a LNB and for providing data communication, a signal for a TV, or the like.

The intermediate element is adapted to receive the second signal and generate the third signal by selecting, from the second signal, information with a frequency within the second frequency band. This selection may, as was the situation in the receiver, be a filtering of the second signal. Naturally, may other manners of selecting a frequency portion of a signal exist, such as the selection, as is described above, of a local oscillator synchronized to the desired frequency.

Naturally, the third signal may be provided in any desired frequency band/interval, so that the intermediate element may not only select a part of the first frequency interval/band but also shift the overall frequency of the signal.

Thus, according to the invention, the receiver may be used with the processing element even though the receiver outputs a signal with a too wide frequency interval/band, as the intermediate element is adapted to adapt this signal and select the desired portion of the first frequency band for the processing element.

In a preferred embodiment:
the receiver is configurable based on a received first configuration signal to select one of the first frequency bands,
the processing element is adapted to output a second configuration signal identifying the second frequency band, and
the intermediate element being adapted to convert the second configuration signal into the first configuration signal and perform the selection on the basis of the second configuration signal.

Thus, in this embodiment, the receiver is able to select the first frequency band on the basis of a received signal. In one situation, this received signal identifies, directly or indirectly, a local oscillator used for generating the second signal from the received signal within the selected first frequency band.

The processing element outputs a second configuration signal identifying the second frequency band.

Naturally, the first and second configuration signals may be of the same or different types. These signals may directly identify the frequency interval(s) selected/identified or may simply indirectly identify these by comprising information from which this interval/band may be determined, such as from a look-up table. Preferably, the first and/or second configuration signals differ when identifying different first/second frequency intervals/bands.

The intermediate element is adapted to, from the second configuration signal, generate the correct first configuration signal so that the correct first frequency interval/band is selected within which the identified second frequency interval/band is provided, or at least where an overlap exists. However, the intermediate element is also adapted to also perform the selection, such as a filtration, and thus the generation of the third signal, on the basis of the second configuration signal.

Thus, the intermediate element may function as a converter simulating, together with the receiver, a receiver adapted to output only the second signal in accordance with the second configuration signal.

In addition to, or as a further part of, the second configuration signals, the processing element may also output information relating to other characteristics of the signal, such as a desired polarization thereof. Such information may be forwarded, by the intermediate element, to the receiver which then acts accordingly. In the situation of different polarizations, the receiver then will select the polarization ordered.

In a second aspect, the invention relates to a method of receiving information, the method comprising:
configuring a receiver to receive signals within a selected one of a plurality of first frequency bands,
the configured receiver receiving a signal within the selected first frequency band and outputting a second signal relating to the signal received within a selected one of the first frequency bands,
a processing element receiving and processing a third signal being within a predetermined, second frequency band, each first frequency band being wider in frequency than the second frequency band, and
an intermediate element receiving the second signal, generating the third signal by selecting, from the second signal, information with a frequency within the second frequency band, and output the third signal.

In the present context, the configuration of the receiver means that the receiver is brought to either only receive signals within the selected one of a plurality of first frequency bands, or at least output only the second signal relating to the signal received within a selected one of the first frequency bands. As mentioned above, this configuration may be manual, such as the flipping of a switch, or the providing of a filter between the receiver and a transmitter of the signals, such as a satellite.

Alternatively, as will be elaborated on below, the configuration may be electronical/optical, so that the receiver, or at least the configuration thereof may be remotely controlled.

The output second signal may, as described above, be of the same type (such encoding/modulation) as the signal received within the first frequency band, or the encoding/modulation/carrier frequency may be altered.

As described above, the processing of the third signal may be any type of processing, such as the mere outputting thereof to another apparatus, such as a communication device, network, telephone, computer, server, TV, monitor, display, or the like. This processing may be a conversion, such as a frequency conversion, a modulation, demodulation, encryption, decryption, decoding or encoding of the received signal.

Many reasons may exist as to why the processing element would accept only signals within the second frequency band.

The intermediate element receives the second signal and generates the third signal by selecting, from the second signal, information with a frequency within the second frequency band. Again, this selection may be a filtering of the received signal. However, also other manners of selecting this frequency range, or a predetermined signal within this frequency range, exist.

In a preferred embodiment:
the configuration step comprises receiving a first configuration signal and selecting, on the basis of the first configuration signal, the selected one of the first frequency bands,
the processing element outputting a second configuration signal, and
the intermediate element converting the second configuration signal into the first configuration signal and performing the selection on the basis of the second configuration signal.

As mentioned, the intermediate element may simulate a receiver outputting the third signal and being configurable with the second configuration signal even though the receiver outputs the second signal which has a wider frequency band/interval, and the intermediate element selects the desired part of the this wider frequency band/interval and forwards it to the processing element.

In the following, preferred embodiments will be described with reference to the drawing, wherein:

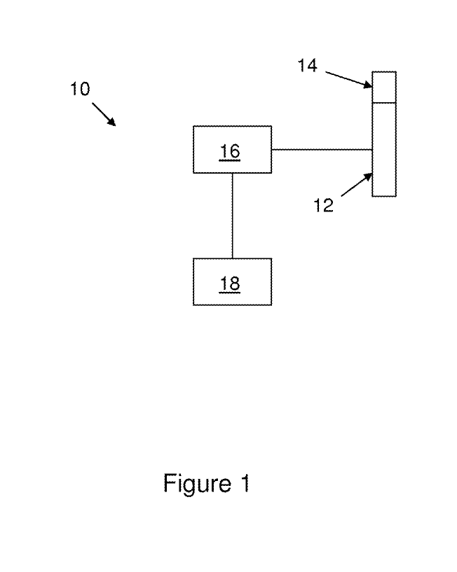

FIG. 1 is a block diagram of a system according to the invention.

FIG. 1 illustrates a system 10 comprising an antenna 12, such as a satellite disc having one or more Low Noise Blocks (LNBs) each of which is able to receive radiation within each of a number of frequency intervals or frequency bands. Each LNB is able to select and output the signal within one of these frequency intervals/bands by mixing the incoming signal with a frequency from a local oscillator 14. The LNBs typically have a local oscillator for each frequency interval/band.

The signal from the antenna 12 is output to an intermediate mixer 16 which outputs another signal to the modem 18 which is to receive and process the signal from the antenna 12. The modem 18 then performs the signal processing, such as decoding etc. which is normally performed to derive the actual contents of the signal.

In prior art systems, the frequency intervals/bands of the LNBs correspond to those which can be handled by the modem 18, but newer LNBs output frequency bands/intervals which are broader than what can be handled by the modem 18.

To be able to use the new LNBs but not require replacement of the legacy modems 18, the mixer 16 is provided for receiving the broader band/interval signals from the antenna 12 and convert these to narrower band/interval signals and feed these to the modem 18.

In one situation, the selection of the frequency band/interval and thus local oscillator 14 in the antenna 12 is made manually (such as by a switch on the antenna 12). In another system, the antenna 12 may be controllable by a signal received. The modem 18 may be adapted to output such a controlling signal, and the mixer 16 may then be adapted to receive the controlling signal from the modem 18 and feed a controlling signal to the antenna 12.

A simple example is that in which the modem can receive either frequency band 1, 2, 3 or 4, where the antenna is able to output frequency bands 1 and 2 combined and 3 and 4 combined. The modem 18 thus outputs a signal identifying e.g. band 2. This signal is received by the mixer 16 which uses it for both instructing the antenna 12 to output the combined bands 1 and 2 and to select, from the signal received from the antenna 12, the band 2 and feed this to the modem 18.

Thus, in a more real life example, when information about the Ku-band RX frequency band (this frequency band is known by the Modem 18 or the Modem operator) is transferred from the Modem 18 to a control circuit around the mixer 16, it is possible to ensure that an otherwise “out of range” IF is shifted into the allowed RX IF range. The information transfer can be through a human operator or by electronic signalling. One bit is required for selection of one out of e.g. two LNB LOs, and an extra bit is required for selection of e.g. one out of two extra mixer LOs to select the frequency band output to the modem 18. The two extra mixer LOs would typically be equivalent to 0 MHz and 500 MHz.

Traditionally the connection between the indoor unit (Antenna Control Unit plus Modem 18) and the outdoor unit (Antenna 12) for a VSAT system includes minimum 2 cables—often more. The 2 cables are coax cables. Two coax cables are required, because transmit (TX) and receive (RX) signals are carried by overlapping L-band intermediate frequencies (IFs), this is dictated by the available VSAT Modems, LNBs and BUCs. Further cables might be added for antenna power and housekeeping communication between indoor and outdoor unit.

In order to combine all signals (RX, TX, modem, power etc.) into one cable, the problem concerning overlapping IF's must be solved. One approach is to use the knowledge about the specific transponder (channel) received by the VSAT Modem. This information is available from the control interface on the VSAT Modem.

When it is not needed to supply the full, received bandwidth to the modem—but only the relative narrow bandwidth containing the signal of interest—it is possible to pick the transponder bandwidth of interest (such as around 54 MHz) inside the antenna, mix it down to a frequency below the IF range occupied by the transmitter, feed it on to the single coax cable (where it can travel to the ACU undisturbed), pick it up again inside the ACU, mix it back to its original frequency and supply it to the VSAT Modem on the RX connector. The VSAT Modem remains unaware of the fact that the received signal has been send over the coax cable at another IF.

In case of this “single cable” solution where the RX IF signal already has been shifted to an other frequency just after the LNB (in order to be combined with other signals on a single cable) the above described frequency shift can also be accomplished if the frequency shifted RX IF signal is not mixed back to the original IF in front of the Modem, but e.g. a 500 MHz lower frequency (in case the original frequency would have been above 1500 MHz), it will appear to the VSAT Modem as if the antenna was equipped with a 4-band LNB instead of the actual 2-band LNB. The virtual 4-band LNB has emerged.

Actually an arbitrary virtual N-band LNB can be created, where N in principle can be any integer from 1 and up. The number of bits required to select LO frequencies will of course have to be increased correspondingly. The real LNB can also theoretically be N-band, where N in principle can be any integer from 1 and up.

In real life probably only N=2, 3 and 4 are of interest—at least these are the only types which are available from LNB manufactures.

It is also possible to make virtual shifts of the LNBs LOs. A LNB with LOs at e.g. 9.75 and 10.75 GHz could be treated, such that it appears to have LOs at e.g. 9.60 and 10.70 GHz. This gives the freedom to match nearly any LNB requirement posed by a VSAT Modem.

1. A system for receiving information, the system comprising:
a receiver being configurable to receive signals within a plurality of first frequency bands and output a second signal relating to a signal received within a selected one of the first frequency bands,
a processing element adapted to receive and process a third signal being within a predetermined, second frequency band, each first frequency band being wider in frequency than the second frequency band, and
an intermediate element adapted to receive the second signal, generate the third signal by selecting, from the second signal, information with a frequency within the second frequency band, and output the third signal.

2. A system according to claim 1, wherein:
the receiver is configurable based on a received first configuration signal to select one of the first frequency bands,
the processing element is adapted to output a second configuration signal, and
the intermediate element being adapted to convert the second configuration signal into the first configuration signal and perform the selection on the basis of the second configuration signal.

3. A method of receiving information, the method comprising:
configuring a receiver to receive signals within a selected one of a plurality of first frequency bands,
the configured receiver receiving a signal within the selected first frequency band and outputting a second signal relating to the signal received within a selected one of the first frequency bands,
a processing element receiving and processing a third signal being within a predetermined, second frequency band, each first frequency band being wider in frequency than the second frequency band, and
an intermediate element receiving the second signal, generating the third signal by selecting, from the second signal, information with a frequency within the second frequency band, and output the third signal.

4. A method according to claim 3, wherein:
the configuration step comprises receiving a first configuration signal and selecting, on the basis of the first configuration signal, the selected one of the first frequency bands,
the processing element outputting a second configuration signal, and
the intermediate element converting the second configuration signal into the first configuration signal and performing the selection on the basis of the second configuration signal.
